(19) United States
(12) Patent Application Publication
(10) Pub. No.: US 2011/0298632 A1
(43) Pub. Date: Dec. 8, 2011

(54) Totally 110 volt AC door alarm system

(76) Inventor: Anthony P. Romeo, Fair Oaks, CA (US)

(21) Appl. No.: 12/927,979

(22) Filed: Feb. 17, 2011

Related U.S. Application Data
(60) Provisional application No. 61/397,244, filed on Jun. 7, 2010.

(51) Int. Cl. G08B 23/00

(52) U.S. Cl. 340/693.5

(57) ABSTRACT

This alarm system operates on 110 volt AC and provides audio and light illumination. Toggle switch (19) is enclosed in switch box (28). It has a flat rectangular flexible extension strip (20) attached to its knob (24). Switch box (28) is attached to assembly bracket (17), component (16). Assembly bracket (17) is then fastened to either a wall on the swinging side of a single door or to the stationary side of a double door, as applicable. Bracket (17) is designed to insure proper distance for a door swinging in and out to strike a flat rectangular flexible extended strip. (20) at the optimum moment to turn switch (19) on and off which activates/deactivates an alarm circuit. This occurs when main wall mounted toggle switch (40) is turned on. Template (35) is used to designate the location of attaching assembly bracket (17), component 10 to either a door or wall.

### CROSS-REFERENCE TO RELATED APPLICATIONS

This application claims the benefit of provisional Patent Application No. 61/397/244, Confirmation No. 7725 filed Jun. 7, 2010 by the present inventor.

### BACKGROUND-PRIOR ART

The following is a tabulation of some prior art that presently appears relevant:

| Patent Number | U.S. Patents | Patentee |
|---|---|---|
| 3,978,467 | 1976 Aug. 31 | Albert |
| 4,754,263 | 1988 Jun. 28 | Trimble |
| D264194 | 1982 May 4 | Jaretsky |
| 3,537,094 | 1970 Oct. 27 | Hawkins/Mandella |
| 2,866,181 | 1958 Dec. 23 | Gordon |

### CLAIM

This alarm system operates on 110 volt AC within the United States and provides audio and light illumination. It does not use sensors, solenoids, transformers, relays, micro switches or rectifiers. The action of a door swinging in and out and striking a flat rectangular flexible extended strip attached to a knob of a toggle switch enclosed in a switch box which is attached to an assembly bracket fastened to a wall on the swinging side of a single door or on the stationary side of a double door turns an alarm circuit on and off.

The flat rectangular extension strip used in this system is made from a plastic material called Bonding UHMW-PE. Due to its molecular makeup, it is extremely wear, impact and chemically resistant. The 15/20amp, 120/277 volt AC/CA toggle switch used in this invention makes this alarm system adaptable for foreign use. This alarm system is simple, economical, and adaptable to homes, apartments, and new housing construction.

### OPERATION

The opening and closing of a door striking a flat rectangular flexible extended strip attached to a knob of a single pole, single throw switch enclosed in a switch box activates/deactivates a 110 volt AC circuit that provides both audible and light illumination. This occurs when a main toggle switch is turned on.

### DRAWINGS

FIG. 1 is a side view of assembly bracket 17 showing components reference numbers 10, 12, 13, 14, 15 and 16.

FIG. 1A is a side view of assembly bracket 17 in an idealized representation.

FIG. 2 is a side view of toggle switch box 28 with enclosed toggle switch 19 attached to assembly bracket 17, component 16.

FIG. 3 is a side view of template 35 showing components 30, 32 and 34 that measure the location of attaching assembly bracket 17, component 10 to either a wall on the swinging side of a single door or the stationary side of a double door.

FIG. 3A is a side view of template 35 in an idealized representation.

FIG. 4 is a view of non-standard symbol components in an alarm circuit.

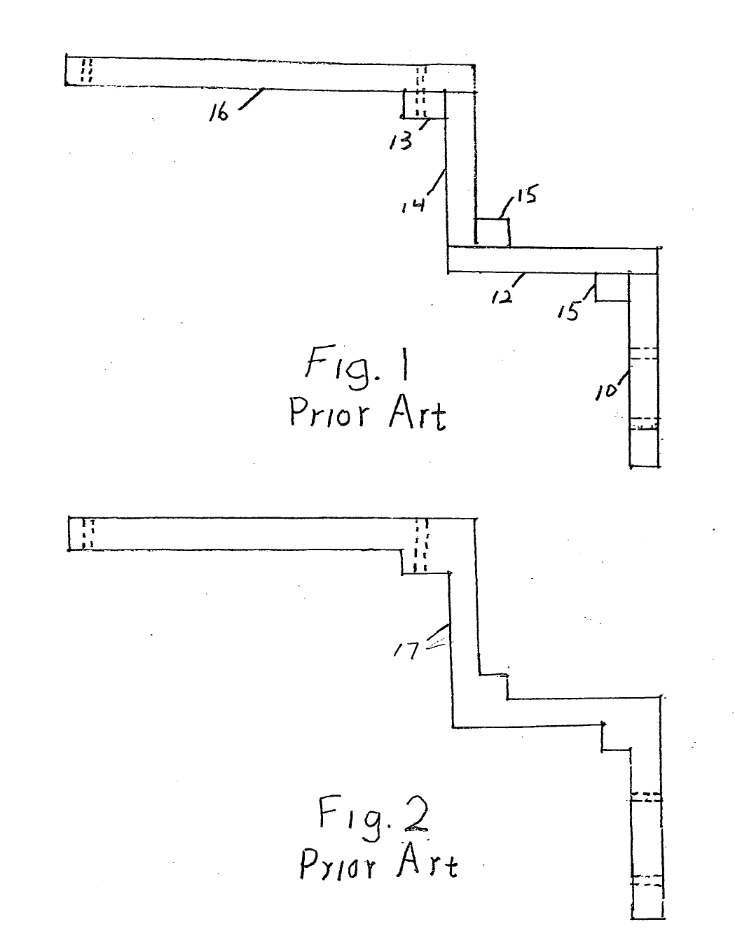

### DESCRIPTION

Seven (7) pieces of acrylic plastic are bonded together to fabricate assembly bracket 17.

Measurement pertaining to assembly bracket components are as follows:

| LENGTH | WIDTH | THICKNESS |
|---|---|---|
| cm 4.45 × | cm 2.54 × | cm 0.64 10 |
| cm 4.76 × | cm 2.54 × | cm 0.64 12 |
| cm 2.54 × | cm 2.54 × | cm 0.64 13 |
| cm 3.81 × | cm 2.54 × | cm 0.64 14 |
| cm 2.54 × | cm 0.64 × | cm 0.64 15 |
| cm 10.16 × | cm 2.54 × | cm 0.64 16 |

Two components 13 and 15 of assembly bracket 17 are bonded to the 90 degree bends of assembly bracket 17, components 10, 12, and 14. Component 13 is bonded to the 90 degree bend of assembly bracket 17, components 14 and 16.

Two (2) each assembly bracket 17 mounting holes cm0.40 will be drilled in assembly bracket component 10, cm0.64 on the unbounded side and cm1.91 on the side bonded to component 12. Holes are centered.

Two (2) each cm 0.40 holes will be drilled in assembly bracket 17, component 16, cm0.48 from the unbounded side and cm1.44 from the side bonded to component 14. Holes are centered.

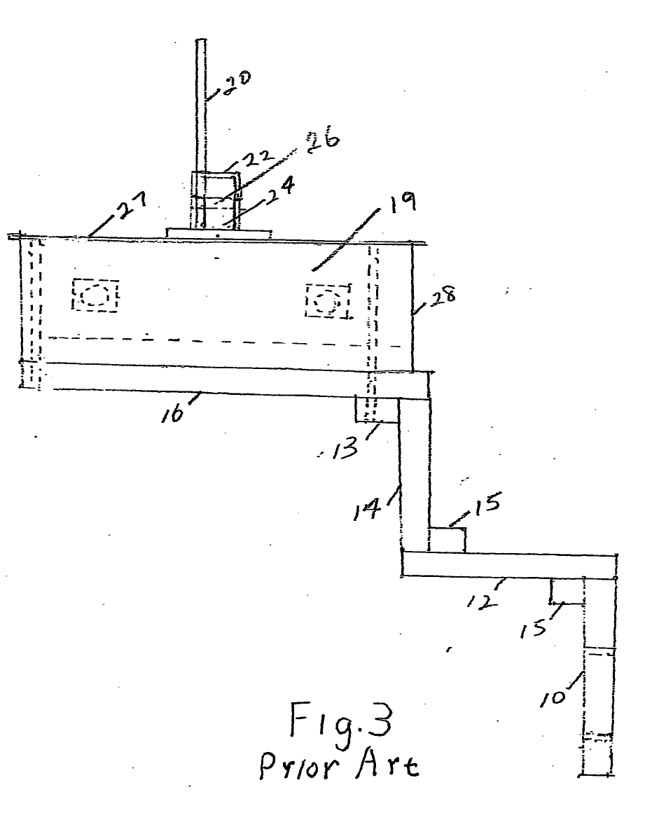

FIG. 2 is a side view of toggle switch box 28 with an enclosed toggle switch 19 attached to assembly bracket 17, component 16.

A cm0.64 wide×cm4.45 long×cm0.16 thick flat flexible rectangular extended strip 20 is cut from a plastic material called Bonding UHMW-PE which due to its molecular makeup is extremely wear, impact and chemically resistant. Position toggle switch knob 24 to its “on” position; while in this position, place the adhesive side of UHMW-PE flat rectangular flexible extended strip 20, cm0.32 from the rear of switch knob 24 and press down firmly to secure a firm bond.

Measure cm0.64 from the front edge of the toggle switch knob 24, center it and drill a cm0.09 hole through knob 24 and flat rectangular flexible extension strip 20.

Insert a cm0.09×cm1.27 machine screw through switch knob 24 then apply medium strength thread locker “blue” to screw end. Tighten with a cm0.09 nut. Then put a cm1.25 piece of polyolefin heat shrink 22 around knob 24 and apply heat. Insert single pole, single throw 15/20A, 120/277 volt AC/CA toggle switch 19 into switch box 28.

Circuit wiring is then inserted into switch box 28 and wired into toggle switch 19. Attach toggle switch 19 to switch box 28 utilizing machine screws that come with toggle switch 19. Fasten switch box 28, cover 27 to switch box 28.

Then attach toggle switch box 28 to assembly bracket 17, component 16 using two (2) each cm0.40×cm5.08 machine screws and tighten with cm0.40 nuts and lock washers. Attach cover 27 to switch box 28. Make sure that switch knob 24 is on the “off” position when attaching assembly bracket 17, component 10 to either a stationary side of a two door entrance or on a wall next to the swinging side of a single door.

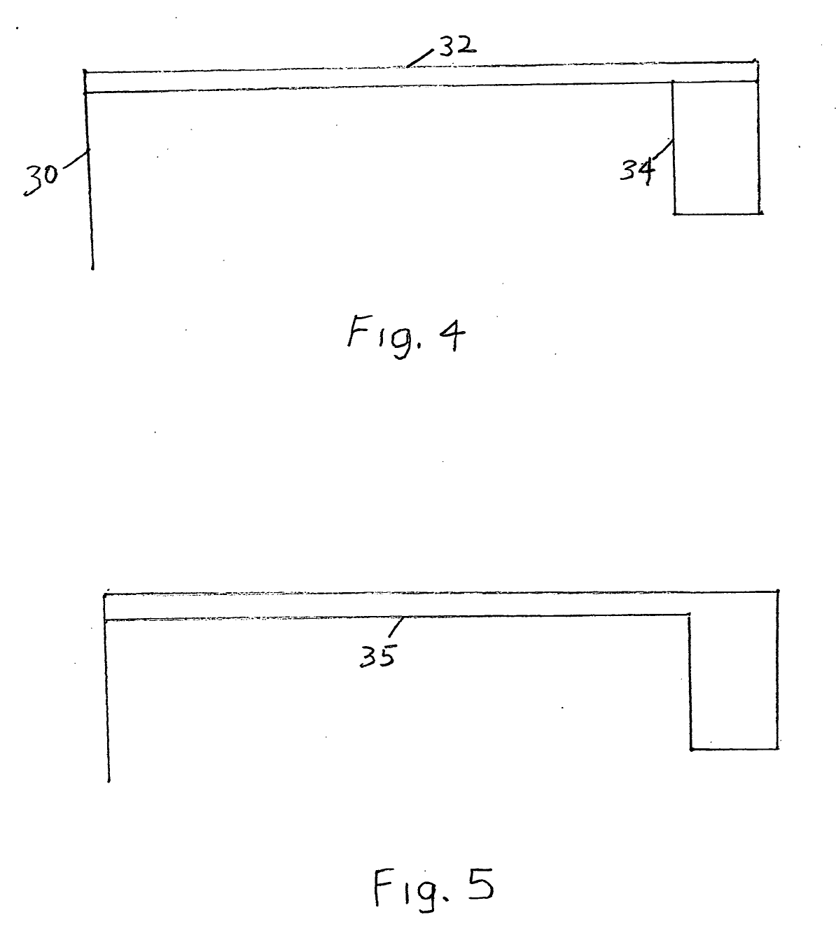

FIG. 3 is a side view of template 35 showing components 30, 32 and 34 that measure the location of attaching assembly bracket 17, component 10 to either a wall on the swing side or a single door or the stationary side of a double door.

FIG. 3A is a side view of template 35 in an idealized representation.

| LENGTH | WIDTH | THICKNESS |
|---|---|---|
| cm 5.08 × | cm 1.91 × | mm 0.600 30 |
| cm 15.88 × | cm 1.91 × | cm 0.64 32 |
| cm 3.18 × | cm 1.91 × | cm 1.91 34 |

For a single door on the swinging side, place aluminum extension 30 of template 35 in the small opening between the door and the door jamb. Then draw a small vertical line on the wall at the other end of template 35, component 34. Place the right side of assembly bracket 17, component 10 on the line and then attach assembly bracket 17 to the wall.

For a double door, on the swinging side, place aluminum extension 30 of template 35 in the small opening between the swinging door and the stationary door.

Then draw a small vertical line at the other end of template 35, component 34, place the right side of assembly bracket 17, component 10 on the line and then attach assembly bracket 17 to the stationary side of the double door.

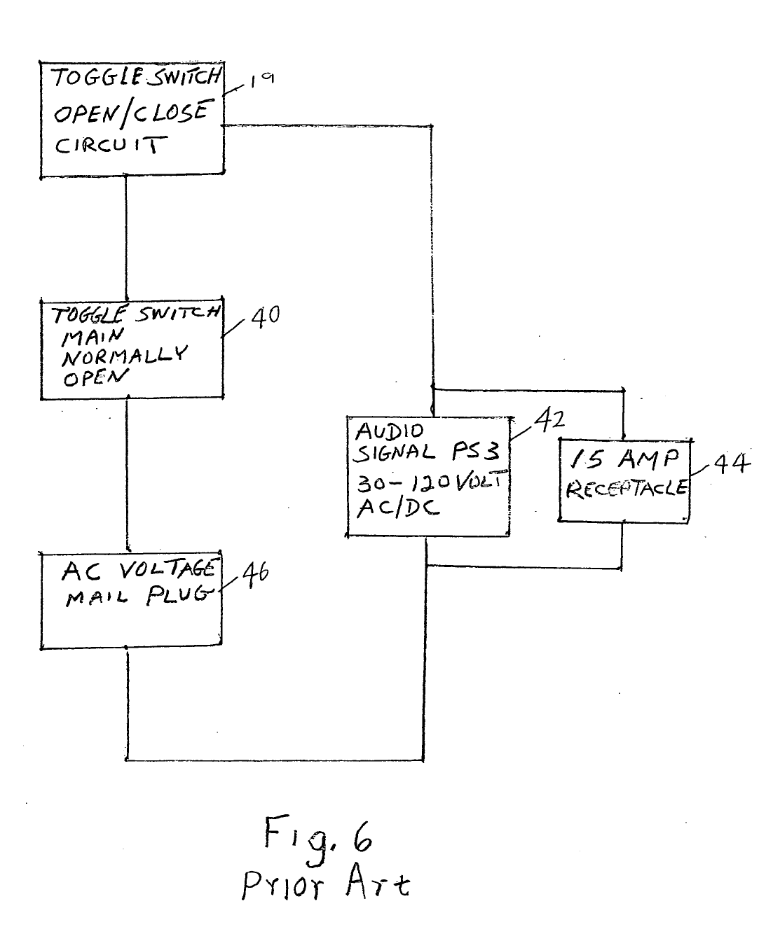

FIG. 4 is a view of non-standard symbol components in an alarm circuit.

Wall mount the following: A main 15 amp, 120 volt AC single pole, single throw toggle switch 40, PIEZO Audio Signal PS3 42, and 15 amp receptacle 44 which will accommodate a light bulb adapter electric socket. Toggle switch 40, PIEZO Audio Signal PS3 42 and 15 amp receptacle 44 will then be wired in series with 110 volt male plug 46 and toggle switch 19. Then wire PIEZO PS3 in parallel with 15 amp, receptacle 44.

### NOVEL FEATURE

A flat rectangular flexible extended strip attached to knob 24 of toggle switch 19 is believed to be entirely new. Assembly bracket 17 is also believed to be entirely new because of its unique design which provides precise placement location of circuit box 28 on a wall/stationary side of a door. This provides precise door striking of flat rectangular flexible extended strip 20.

REFERENCE NUMERALS

| | |
|---|---|
| 10 | plastic assembly component |
| 12 | plastic assembly component |
| 13 | plastic assembly component |
| 14 | plastic assembly component |
| 15 | plastic assembly component |
| 16 | plastic assembly component |
| 17 | assembly bracket |
| 19 | enclosed toggle switch |
| 20 | flat rectangular flexible extended strip |
| 22 | heat shrink tubing |
| 24 | toggle switch knob |
| 26 | switch knob screw and nut |
| 27 | switch box cover |
| 28 | toggle switch box |
| 30 | template component, aluminum |
| 32 | template component |
| 34 | template component |
| 44 | 15 amp receptacle |
| 46 | 110 volt male plug |

I claim:

1. An alarm system that has a flat rectangular elongated plastic strip attached to the knob of a toggle switch.

2. The strip of claim 1 whose body of material is composed of polyethylene.

3. The strip of claim 1 due to its molecular makeup is extremely wear and impact resistant.

4. The strip of claim 1 is pliable. When struck by a door traveling in or out, it is flexed. This action turns a toggle switch “on” or “off” depending upon which direction the door is traveling. Instantly after the flexing takes place, the strip reverts back to its normal straight position on the toggle switch knob.

5. An alarm system that has a toggle switch with a flat rectangular elongated plastic strip attached to the “on” side of its knob, enclosed in a switch box mounted on an assembly bracket which is attached to either a wall on the swinging side of a single door or the stationary side of a double door, said switch is connected to an alarm circuit. When a door is opened legally or illegally, it will travel to a predetermined distance and strike and flex the toggle switch's elongated plastic strip. This flexing action turns the switch knob to its “on” position. The alarm circuit will only energize if the circuit main switch is on the “on” position.

6. When a door is in the process of being closed, it will strike and flex the alarm system's toggle switch elongated strip which will place the toggle switch knob in the “off” position.

7. An alarm system bracket assembly that is unique because of its design which upon proper measurement by a template places the toggle switch attached to it in the most optimum position to be struck and flexed by a door opening and closing.

8. An alarm system that uses no batteries or sensors. It uses 110 volts only.
